(19) United States
(12) Patent Application Publication
(10) Pub. No.: US 2020/0233249 A1
(43) Pub. Date: Jul. 23, 2020

(54) LIQUID CRYSTAL DISPLAY PANEL

(71) Applicant: Wuhan China Star Optoelectronics Technology Co., Ltd., Wuhan (CN)

(72) Inventor: Wei TANG, Wuhan (CN)

(73) Assignee: Wuhan China Star Optoelectronics Technology Co., Ltd., Wuhan (CN)

(21) Appl. No.: 16/494,301

(22) PCT Filed: Nov. 19, 2018
(86) PCT No.: PCT/CN2018/116243

§ 371 Date: Sep. 15, 2019

(30) Foreign Application Priority Data
Jul. 26, 2018 (CN) 201810832644.5

(51) Int. Cl. G02F 1/1368

(52) U.S. Cl. CPC G02F 1/1368; G02F 2001/136222

(57) ABSTRACT

A liquid crystal display panel is provided, including an array substrate and a color filter substrate disposed opposite to the array substrate; the array substrate includes a first region, and a second region is disposed on at least one side of the first region; a TFT array is disposed in the first region; and the color filter substrate is correspondingly disposed in the first region; wherein an end of the second region is provided with at least one alignment mark, the alignment mark is electrically connected to a common electrode of the TFT array; the alignment mark is a silver paste dot mark.

### BACKGROUND OF APPLICATION

### Field of Application

The present application relates to the field of display technologies, and in particular, to a liquid crystal display panel.

### Description of Prior Art

A display region of a current mobile display screen is increasing, and the region of an outer lead bonding (OLB) region of liquid crystal display (LCD) panel is compressed, which is particularly disadvantageous for chip on glass (COG) encapsulation. At present, a box alignment mark and a silver paste dot mark are disposed on the left and right sides of a border of a thin film transistor (TFT array) panel, and they are placed adjacent to each other. The box alignment mark is a solid cross mark, and the center of the silver paste dot mark is another cross mark. The box alignment mark of a liquid crystal cell and the silver paste dot mark in the bonding region are separately positioned, thereby a lot of space on the OLB region is wasted, which is disadvantageous for external circuit connections and further affects quality of display panels.

### SUMMARY OF APPLICATION

The present application provides a liquid crystal display (LCD) panel with an alignment mark, which replaces the box alignment mark and silver paste dot mark of the existing cell segment. The alignment mark of the present application can achieve precise positioning, and at the same time, silver paste can be disposed on the alignment mark to connect the common electrode of the array substrate and the color film substrate, thereby the region of the OLB region can be considerably saved.

The present application provides a LCD panel, which comprises an array substrate and a color filter substrate disposed opposite to the array substrate;

the array substrate comprises a first region, and a second region is disposed on at least one side of the first region; a thin film transistor array (TFT array) is disposed in the first region; and the color filter substrate is correspondingly disposed in the first region;

wherein an end of the second region is provided with at least one alignment mark, the alignment mark is electrically connected to a common electrode of the TFT array; the alignment mark is a silver paste dot mark, and is used for performing alignment of a cell segment;

the alignment mark comprises a metal layer which is electrically connected to the common electrode of the TFT array; and

the second region is rectangular in shape.

In the LCD panel of the present application, the metal layer of the alignment mark is square in shape and has a cross-shaped hollow.

In the LCD panel of the present application, a top layer of the alignment mark has an indium tin oxide layer, and the indium tin oxide layer is electrically connected to the metal layer.

In the LCD panel of the present application, the indium tin oxide layer completely covers the metal layer.

In the LCD panel of the present application, the indium tin oxide layer has a square shape, and a center point of the indium tin oxide layer overlaps with a center point of the metal layer.

In the LCD panel of the present application, a side length of the indium tin oxide layer is longer than a side length of the metal layer by at least 400 μm.

In the LCD panel of the present application, a side of the alignment mark is closest to a short side of the second region, and the distance between the side of the alignment mark and the short side of the second region is at least 300 μm.

In the LCD panel of the present application, a longest distance from any point of the alignment mark to an edge of the color filter substrate is 1500 μm.

In the LCD panel of the present application, the alignment mark is used to provide a position indication for the subsequent cutting alignment, polarizer adhesive alignment, or lighting alignment.

The present application further provides a LCD panel comprising an array substrate and a color filter substrate disposed opposite to the array substrate;

the array substrate comprises a first region, and a second region is disposed on at least one side of the first region; a thin film transistor array (TFT array) is disposed in the first region; and the color filter substrate is correspondingly disposed in the first region;

wherein an end of the second region is provided with at least one alignment mark, the alignment mark is electrically connected to a common electrode of the TFT array; the alignment mark is a silver paste dot mark, and is used for performing alignment of a cell segment.

In the LCD panel of the present application, the alignment mark comprises a metal layer which is electrically connected to the common electrode of the TFT array.

In the LCD panel of the present application, the metal layer of the alignment mark is square and has a cross-shaped hollow.

In the LCD panel of the present application, the top layer of the alignment mark has an indium tin oxide layer, and the indium tin oxide layer is electrically connected to the metal layer.

In the LCD panel of the present application, the indium tin oxide layer completely covers the metal layer.

In the LCD panel of the present application, the indium tin oxide layer has a square shape, and a center point of the indium tin oxide layer overlaps with a center point of the metal layer.

In the LCD panel of the present application, a side length of the indium tin oxide layer is longer than a side length of the metal layer by at least 400 μm.

In the LCD panel of the present application, the second region is rectangular.

In the LCD panel of the present application, a side of the alignment mark is closest to a short side of the second region, and the distance between the side of the alignment mark and the short side of the second region is at least 300 μm.

In the LCD panel of the present application, a longest distance from any point of the alignment mark to an edge of the color filter substrate is 1500 μm.

In the LCD panel of the present application, the alignment mark is used to provide a position indication for the subsequent cutting alignment, polarizer adhesive alignment or lighting alignment.

The LCD panel provided by the present application is provided with an alignment mark, which can function as a precise position, and also can dispose a silver dot on the alignment mark to connect the common electrode of the array substrate and the color filter substrate, thereby saving the area of the OLB region, which is advantageous for external circuit connection and further improves the quality of the display panel.

### BRIEF DESCRIPTION OF DRAWINGS

The present application will be further described in detail with reference to the accompanying drawings and specific embodiments.

FIG. 1 is a structural top view of a liquid crystal display (LCD) panel provided by an embodiment of the present application.

FIG. 2 is a structural diagram of an alignment mark provided by an embodiment of the present application.

FIG. 3 is a cross-sectional view of the LCD panel in an AA′ direction of an embodiment of the present application.

### DETAILED DESCRIPTION OF PREFERRED EMBODIMENTS

The technical solutions in the embodiments of the present application will be clearly and completely described in the following with reference to the accompanying drawings in the embodiments. It is apparent that the described embodiments are only a part of the embodiments of the present application, and not all of them. All other embodiments obtained by a person skilled in the art based on the embodiments of the present application without creative efforts are within the scope of the present application.

A box alignment mark and a silver paste dot mark of an outer lead bonding (OLB) region of a liquid crystal cell are separated, as a result, a lot of space on the OLB region is wasted. A liquid crystal display (LCD) panel provided by the present application is provided with an alignment mark, which can function as a precise position, and also can dispose the silver paste dot mark on the alignment mark to connect a common electrode of an array substrate and a color filter substrate, thereby saving the space of the OLB region, which is advantageous for external circuit connections and further improves the quality of the display panel.

It should be noted that “cell” refers to a panel in which a liquid crystal material is sealed in a gap of several micrometers formed by combining two glass substrates.

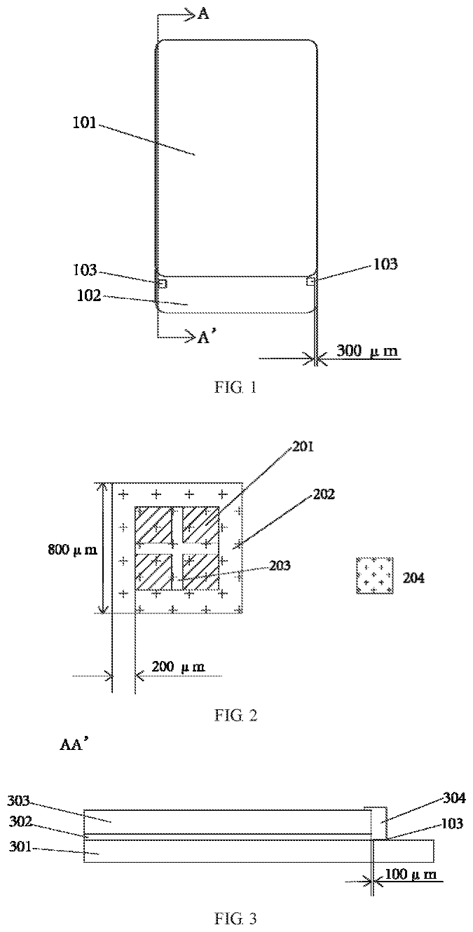

FIG. 1 and FIG. 3 are structural diagrams showing a structure of a LCD panel according to an embodiment of the present application. The LCD panel includes an array substrate 301, a color filter substrate 303, and a liquid crystal 302 between the array substrate 301 and the color filter substrate 303. The color filter substrate 303 is disposed in a first region 101. An alignment mark 103 is disposed in a second region 102 and is located near a short side of the second region 102 and an edge of the color filter substrate 303. The distance between a side of the alignment mark 103 and a short side of the second region 102 is at least 300 μm. The distance between a side of the alignment mark 103 and the color filter substrate 303 is at least 100 μm.

In a process of manufacturing a liquid crystal cell, after the array substrate 301 is deposited with a thin film transistor (TFT array) array, a seal is coated on edges of the first region 101 of the array substrate. The liquid crystal 302 is injected into the seal of the first region 101. Finally, the color filter substrate 303 is attached to the first region 101. One use of the alignment mark 103 is to drop enough conductive silver paste 304 on the alignment mark 103 to connect a common electrode of the color filter substrate in the subsequent process, so that the array substrate is connected to the common electrode of the color filter substrate, thereby functioning to conduct static electricity.

Therefore, the alignment mark 103 requires the common electrode that can conduct electricity and connect with the array substrate. As shown in FIG. 2, which is a structural diagram of the alignment mark 103, wherein the common electrode of a metal layer 201 connecting with the array substrate is square in shape, and a cross-shaped hollow mark 203 is disposed in the metal layer 201. An indium tin oxide layer 204 is a transparent electrode, which is square in shape and located on the top of the alignment mark 103. The indium tin oxide layer 204 has a side length of 800 μm and completely covers the metal layer 201. The indium tin oxide layer 204 is electrically connected with the metal layer 201, and a center point of the indium tin oxide layer 204 overlaps with a center point of the metal layer 201. The indium tin oxide layer 204 does not cover an outer region 202 of the metal layer 201. The outer region 202 is a region where the conductive silver paste is disposed, and having a width of at least 200 μm.

In addition to the drop of the conductive silver paste, the alignment mark 103 can also serve as a position indication mark in a cell segment process. The hollow mark 203 of the alignment mark is a cross shape, and can provide a position indication for subsequent cutting, polarizer attachment, and lighting tests, if relevant devices are set with corresponding identification strategies.

Because the existing alignment mark and the conductive silver paste are separately disposed and are both cross-shaped, in order to save space, the present application combines the two marks, moves the combined mark to the left and right edges of the second region 102. Removing the alignment mark of the liquid crystal cell and confirming with a cell process, the combined mark can be used to perform machine test adjustment. The combined alignment mark can also be used to perform cell segment alignment. A total of 1200 μm can be saved on both sides. In addition, the conductive silver paste can be used to connect the array substrate 301 and the color filter substrate 303. If the combined alignment marks were appropriately adjusted: 1000 μm→800 μm, and a total of 400 μm can be further saved, the space of the outer lead bonding (OLB) is greatly saved, which is beneficial to adjusting panel design and provides space for more useful test keys, such as test element group (TEG) test key (used for electrical monitoring) or dummy test key (used for product characteristic value monitoring). Compared with prior art, the present application increases available space in the OLB region and improves product design flexibility, especially for space-limited chip on glass (COG) products, advantages generated by the present application are quite obvious.

The LCD panel provided by the present application is provided with an alignment mark. The alignment mark is used to perform cell segment alignment and replaces a liquid crystal cell alignment mark and a dot silver glue mark in the existing design. The alignment mark can function as a precise position, and can also dispose a silver dot on the alignment mark to connect a common electrode of an array substrate and a color filter substrate, thereby saving the space of an OLB region, which is advantageous for external circuit connections and further improves the quality of the display panel.

What is claimed is:

1. A liquid crystal display (LCD) panel comprising an array substrate and a color filter substrate disposed opposite to the array substrate;
the array substrate comprises a first region, and a second region is disposed on at least one side of the first region; a thin film transistor (TFT array) array is disposed in the first region; and the color filter substrate is correspondingly disposed in the first region;
wherein an end of the second region is provided with at least one alignment mark, the alignment mark is electrically connected to a common electrode of the TFT array array; the alignment mark is a silver paste dot mark, and is used for performing alignment of a cell segment;
the alignment mark comprises a metal layer which is electrically connected to the common electrode of the TFT array array; and
the second region is rectangular in shape.

2. The LCD panel according to claim 1, wherein the metal layer of the alignment mark is square in shape and has a cross-shaped hollow.

3. The LCD panel according to claim 2, wherein a top layer of the alignment mark has an indium tin oxide layer, and the indium tin oxide layer is electrically connected to the metal layer.

4. The LCD panel according to claim 3, wherein the indium tin oxide layer completely covers the metal layer.

5. The LCD panel according to claim 4, wherein the indium tin oxide layer has a square shape, and a center point of the indium tin oxide layer overlaps with a center point of the metal layer.

6. The LCD panel according to claim 5, wherein a side length of the indium tin oxide layer is longer than a side length of the metal layer by at least 400 μm.

7. The LCD panel according to claim 1, wherein a side of the alignment mark is closest to a short side of the second region, and the distance between the side of the alignment mark and the short side of the second region is at least 300 μm.

8. The LCD panel according to claim 1, wherein a longest distance from any point of the alignment mark to an edge of the color filter substrate is 1500 μm.

9. The LCD panel according to claim 1, wherein the alignment mark is used to provide a position indication for the subsequent cutting alignment, polarizer adhesive alignment, or lighting alignment.

10. A liquid crystal display (LCD) panel comprising an array substrate and a color filter substrate disposed opposite to the array substrate;
the array substrate comprises a first region, and a second region is disposed on at least one side of the first region; a thin film transistor (TFT array) array is disposed in the first region; and the color filter substrate is correspondingly disposed in the first region;
wherein an end of the second region is provided with at least one alignment mark, the alignment mark is electrically connected to a common electrode of the TFT array array; the alignment mark is a silver paste dot mark, and is used for performing alignment of a cell segment.

11. The LCD panel according to claim 10, wherein the alignment mark comprises a metal layer which is electrically connected to the common electrode of the TFT array array.

12. The LCD panel according to claim 11, wherein the metal layer of the alignment mark is square in shape and has a cross-shaped hollow.

13. The LCD panel according to claim 12, wherein a top layer of the alignment mark has an indium tin oxide layer, and the indium tin oxide layer is electrically connected to the metal layer.

14. The LCD panel according to claim 13, wherein the indium tin oxide layer completely covers the metal layer.

15. The LCD panel according to claim 14, wherein the indium tin oxide layer has a square shape, and a center point of the indium tin oxide layer overlaps with a center point of the metal layer.

16. The LCD panel according to claim 15, wherein a side length of the indium tin oxide layer is longer than a side length of the metal layer by at least 400 μm.

17. The LCD panel according to claim 10, wherein the second region is rectangular in shape.

18. The LCD panel according to claim 17, wherein a side of the alignment mark is closest to a short side of the second region, and the distance between the side of the alignment mark and the short side of the second region is at least 300 μm.

19. The LCD panel according to claim 10, wherein a longest distance from any point of the alignment mark to an edge of the color filter substrate is 1500 μm.

20. The LCD panel according to claim 10, wherein the alignment mark is used to provide a position indication for the subsequent cutting alignment, polarizer adhesive alignment or lighting alignment.
